(19) United States
(12) Patent Application Publication
(10) Pub. No.: US 2011/0138269 A1
(43) Pub. Date: Jun. 9, 2011

(54) METHODS FOR CONVERTING MEDICAL DOCUMENTS AND CORRESPONDING DEVICES AND COMPUTER SOFTWARE

(75) Inventor: Emmanuel Cordonnier, Rennes (FR)

(73) Assignee: ETIAM S.A., Rennes (FR)

(21) Appl. No.: 12/994,704

(22) PCT Filed: May 18, 2009
(86) PCT No.: PCT/EP2009/056031

§ 371 Date: Feb. 16, 2011

(30) Foreign Application Priority Data
May 26, 2008 (FR) 08/53408

(51) Int. Cl. G06F 17/00

(52) U.S. Cl. 715/239

(57) ABSTRACT

A method is provided for converting a source document portrayed in a source format and at least one associated metadatum portrayed in the source format or in a format enabling metadata generation in the source format, into at least one destination document portrayed in a destination format. The source format is compliant with a first protocol for exchanging and/or sharing non-image medical documents, and the destination format is compliant with a second protocol for exchanging and/or sharing medical imaging documents. The method includes the following steps: inserting the source document into a first portion of the destination document; transposing the at least one metadatum into transposed data; and inserting the transposed data into a second portion of the destination document that is different from the first portion.

### CROSS-REFERENCE TO RELATED APPLICATIONS

This Application is a Section 371 National Stage Application of International Application No. PCT/EP2009/056031, filed May 18, 2009 and published as WO 2009/144152 on Dec. 3, 2009, not in English.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF THE DISCLOSURE

The field of the disclosure is that of the management, sharing and exchanging of all types of medical documents.

More specifically, the disclosure relates to the storage and transmission of text type medical documents, medical images, etc.

### BACKGROUND OF THE DISCLOSURE

At present, there are several different digital imaging techniques and different systems for storing and exchanging digital images.

For example, the DICOM standard (Digital Imaging and COmmunication in Medicine), recognised as an international standard by the ISO (International Standards organisation), permits such images to be exchanged in digital form, by maintaining the images themselves permanently linked (in the form of pixels) to the medical information associated (name of the patient, organ shown in the image, etc.).

The digital images thus generated may for example be generated and stored in image archiving and communication systems, such as of the PACS type (Picture Archiving and Communication System), which are capable of managing very large volumes of data.

There are also different formats of medical documents, and different systems of storing and exchanging medical documents.

For example, medical information systems manage medical data in the form of HER (Electronic Health record) form patient files.

In addition to messages carrying structured information such as the identification of patients and their movements within the hospital, often in the HL7 (Health Level Seven) format, the IHE (Integrating the Healthcare Enterprise) initiative defined a format to share and exchange documents between “patient files” within the XDS (Cross Enterprise Document Sharing) integration profile.

The XDS profile defines a standardised set of meta-data associated to the documents, wherein a meta-datum is a sort of label which allows the “patient files” to manage the documents which compose them correctly, and which may themselves be in different, non-structured formats (text, PDF-Printable Document Format) editable “RTF” (Rich Text format) or structured (XML-eXtensible Markup Language) including HL7 CDA (Clinical Document Architecture).

The IHE XDS profile is considered as a standard recognised for all exchanges of text format medical documents, which is to say that are not in image format.

One disadvantage of these various techniques of the prior art is that no system manages medical documents in several types of different formats.

Consequently, applications which need to present to users both medical documents and their associated images (or vice-versa) must interact with the system which manages the medical documents and the image management system, which may lead to synchronisation problems between the two systems.

The transfer of images and associated documents between two entities supposes in this case two different communications that are not synchronised with one another and that are more complex to implement.

There are also medical information systems that manage images and documents, on the condition that the documents have been created within the context of the imaging system, as external medical documents cannot be managed.

The transfer of images and documents between two entities in this case thus only concerns imaging documents.

Finally, there are medical information systems which manage documents and images in a format suited to the document, which is to say that do not manage the images in a format that is suited to medical imaging.

### SUMMARY

An embodiment of the invention proposes a novel solution in the form of a conversion method from a source document described in a source format and at least one associated meta-datum described in said source format or in a format which permits meta-data to be generated in said source format, to at least one target document described in a target format.

According to an embodiment of the invention, said source format is compliant with a first protocol for the exchange and/or sharing of medical documents and said target format is compliant with a second protocol for the exchange and/or sharing of medical imaging documents and such a method comprises the following steps:
insertion of said source document in a first part of said target document;
transposition of said at least one meta-datum into a second part of said target document,
insertion of said transposed datum into a second part of said target document, distinct from said first part.

Consequently, an embodiment of the invention is based on a novel and inventive approach to the management and the exchange of medical documents and medical imaging documents, in a same format without loss of information.

By medical document, it is meant a document, not an image, which defines information concerning a patient, to examinations undergone by the patient, his/her medical history, visits and stays in hospital, etc. The meta-datum/data associated to a medical document is data which especially permits the associated document in a “patient file” to be managed (which regroups a plurality of documents and information related to a same patient).

By medical imaging documents it is meant images in digital form, which correspond to examinations undergone by the patient, such as for example a radiology, a scan, a Magnetic Resonance Imaging scan, etc.

Consequently, a specific embodiment of the invention permits to convert a medical document and its associated meta-data, described in a format suited to the exchange and sharing of medical documents, to a document described in a format suited to medical imaging.

The principle of an embodiment of the invention is based on a distinct conversion from the source document and associated meta-data, to two parts which are also distinct of a target document.

For example, the medical document is inserted into a part of a target document, pre-identified as a “binary” part of the target document, and the meta-datum/data associated to the medical document which are transposed into data designed to be inserted into a second part of the target document, pre-identified for example as a “header” of the target document.

Consequently, the principle of an embodiment of the invention is based on a transposition of meta-data associated to a medical document into header data of an imaging document (by carrying out suited processing on each meta-datum, which consists of identifying a function of the meta-data) and not on an encapsulation in the target format of “proprietor” type information.

In particular, said transposition step comprises the following sub-steps:
decoding of said at least one meta-datum;
identification, from a plurality of fields comprised in said second part of the target document, of a field which performs a function equivalent to that of said at least one meta-datum;
conversion of said at least one meta-datum into said transposed datum to be inserted into said identified field.

Consequently, according to this embodiment, the transposition of the meta-datum associated to the source document consists of decoding it so as to identify a field which corresponds functionally in the target document.

For example, if we consider that the “header” part of the target document comprises a plurality of fields that carry out various functions, the conversion method according to this embodiment permits the identification, from this plurality of fields, of the one which performs, in the target format, an equivalent function to the function performed by the meta-datum in the source format.

Several criteria are taken into account for the identification of a field whose function is equivalent to that of the meta-datum, and especially information related to the patient to which the medical document is associated, to the examinations the patient has undergone, to the centres in which they have been carried out, to the dates and times of these examinations, etc.

According to one specific characteristic of an embodiment of the invention, said identification step comprises the following sub-steps:
the determination of a level of information of said meta-datum;
the selection of said field in function of said determined level.

Consequently, according to this embodiment, one of the criteria used to identify a field which performs a function that is equivalent to that of the meta-datum corresponds to a level of information of the meta-datum.

Indeed, the meta-data especially describe the medical document to which they are associated, and the possible links between this document and other medical documents related to the same patient for example.

For example, said level of information belongs to the group comprising:
the level related to a patient to whom the source document is linked;
the level related to a set of documents to which said source document belongs, called the submission batch;
the level related to the source document.

Consequently, according to this embodiment, the level of information of a meta-datum may be a level indicating that the meta-datum is related directly to the source document to which it is associated, or to a level indicating that the meta-datum is related to the submission batch of the source document to which it is associated (which is to say the set of documents that the source document is part of) or even a level indicating that the meta-datum is related to the patient to whom the source document is associated or related to an examination that the patient has undergone.

According to one specific aspect of an embodiment of the invention, each of said fields is of a type belonging to the group comprising:
obligatory field;
optional field;
conditional field,

and said method comprises a step for attributing a default value to at least one obligatory field of said target format when no meta-datum which performs an equivalent function is associated to said source document.

Consequently, according to this embodiment of the invention, the method permits a default value to be attributed to an obligatory field, as defined above, when no meta-datum which performs an equivalent function is associated to said source document.

In this manner, an obligatory field is not empty, even if it does not correspond to a meta-datum associated to the source document.

The fields comprised in the second part of the target document may therefore be of different types, in function of their importance.

For example, certain fields are obligatory, which is to say always present in a medical imaging document.

Certain fields are optional, which is to say that they are present or not in a medical imaging document, according to the level of information that is to be achieved for the document in question.

Finally, certain fields are conditional, which is to say that they become obligatory under certain conditions, for example if another field is present then a field may become obligatory.

Advantageously, said conversion step comprises:
a selection step, from a plurality of values for a meta-datum, of a value with a relevancy above a predetermined threshold;
a step for attributing said selected value to said at least one identified field of said target format, when said field may only have one value.

Consequently, the invention permits, according to this embodiment, the most relevant value of a meta-datum to be chosen, when the latter comprises several values and when the field identified for the conversion may only have one value.

In particular, said transposition step takes into account at least one item of information belonging to the group comprising:
an item of information related to a patient;
an item of information related to a submission batch;
an item of information related to said source document.

Consequently, according to this embodiment, the criteria used for the conversion of the meta-datum to a field with an equivalent function may be related:
to the patient to whom the source document is associated: for example, his/her contact details, etc.;
to a series of documents concerning the patient: for example the date and time when the series of documents was created, etc.;
to the source document itself: the date and time when the document was created, the author of the document, the person to whom the document was sent, the type of coding of the document, etc.

These criteria are provided by way of illustration and are not restrictive, and especially permit the function of the meta-datum to be identified and thus permit a search to be carried out for an equivalent function field.

According to one preferred embodiment of the invention, said source format is “IHE-XDS” and said target format is “DICOM”.

Consequently the method according to one embodiment of the invention is especially adapted to a conversion of a “IHE-XDS” type document to a “DICOM” type document.

An embodiment of the invention also relates to a method for the conversion of a source document described in a source format to at least one target document described in a target format and at least one associated meta-datum, described in said target format or in a format which permits the generation of meta-data in said target format.

According to an embodiment of the invention, said source format complies to a first protocol for exchanging and/or sharing medical imaging documents and said target format complies with a second protocol for exchanging and/or sharing non-imaging medical documents, and said method comprises the following steps:
insertion of a first part of said source document in said target document;
transposition of a second part of said source document into at least one meta-datum associated to said target document.

Consequently the invention permits, according to this specific embodiment, to convert a document described in a format adapted to medical imaging to a medical document and one or several associated meta-data, described in a format adapted to the exchanging and sharing of medical documents.

The principle of an embodiment of the invention is based on a distinct conversion of a first part of the source document to a target document, and a second part of the source document to one or several meta-data associated to the target document.

For example, a first part of the source document, pre-identified as a “binary” part, is inserted into a target document, and a second part of the source document, pre-identified for example as a “header”, is transposed to one or several meta-data associated to the target document.

In particular, said transposition step comprises the following sub-steps:
decoding of at least one field of said second part of the source document;
identification of a meta-datum associated to said target document providing a function equivalent to that of said field;
conversion of said field to said at least one meta-datum identified.

Consequently, according to this embodiment, the transposition of a second part of the source document to one or several meta-data associated to the target document consists of decoding the fields comprised in this second part so as to identify the meta-data associated to the target document which corresponds functionally to the decoded fields.

For example, if we consider that the “header” part of the target document comprises a plurality of fields which perform various functions, the conversion method according to this embodiment permits the identification amongst the possible meta-data which may be associated to the target document, the meta-data which perform, in the target format, equivalent functions to the functions performed by the fields in the source format.

Several criteria are taken into account for the identification of a meta-datum with an equivalent function to that of a field comprised in the second part of the source document, and especially the information related to the patient to whom the medical document is associated, to the examinations undergone, to the persons who have carried out these examinations, to the centres in which they were performed, to the dates and times of these examinations, etc.

According to one specific aspect, said identification step comprises the following sub-steps:
determination of a level of information of said identified field;
selection of said meta-data in function of said determined level.

Consequently, according to this embodiment, one of the criteria used to identify a meta-data which performs an equivalent function to that of the field identified corresponds to a level of information of the field.

Indeed, the fields comprised in the second part of the source document especially described the imaging document that they are part of, and the possible links between this document and other imaging documents related to the same patient, for example.

In particular, said level of information belongs to the group comprising:
the level related to a patient to whom said source document is related;
the level related to an examination undergone by the patient;
the level related to a series of documents to which said source document belongs;
the level related to said source document.

Consequently, according to this embodiment, the level of information of a field may be a level which indicates that the field is related directly to the source document, or to a level which indicates that the field is related to the series of documents to which the source document belongs, or even to a level which indicates that the field is related to the patient to whom the source document is associated or related to an examination the patient has undergone.

Advantageously, the method comprises a step for attributing a default value to a meta-datum when no field which performs an equivalent function is identified in said source document.

Consequently, according to this embodiment of the invention, the method permits a default value to be attributed to a meta-datum associated to the target document when no field which performs an equivalent function to this meta-datum is identified in the source document.

In this manner, a meta-datum whose presence is required associated to a target document is not empty, even if it does not correspond to a field in the source document.

According to one specific characteristic of an embodiment of the invention, said transposition step takes into account at least one item of information belonging to the group comprising:
an item of information related to a patient;
an item of information related to an examination;
an item of information related to a submission batch;
an item of information related to said source document.

Consequently, according to this embodiment, the criteria used for the conversion of the meta-datum to a field with an equivalent function may be related:
to the patient to whom the source document is associated: for example, his/her contact details;
to an examination the patient has undergone: for example the date and time of the examination;
to a series of documents concerning the patient: for example the date and time when the series of documents was created;
to the source document itself: the date and time when the document was created, the author of the document, the person to whom the document was sent, the type of coding of the document, etc.

These criteria are provided by way of illustration and are not restrictive, and especially permit the function of the field to be identified and thus permit a search to be carried out for a meta-datum with an equivalent function.

According to one preferred embodiment of the invention, said source format is “DICOM” and said target format is “IHE-XDS”.

An embodiment of the invention also relates to a device for the conversion of a source document described in a source format and at least one associated meta-datum described in said source format or in a format which permits the generation of meta-data in said source format to at least one target document described in a target format.

According to an embodiment of the invention, said source format complies to a first protocol for exchanging and/or sharing medical documents and said target format complies with a second protocol for exchanging and/or sharing medical imaging documents, and said device comprises the following steps:
means of inserting said source document into a first part of said target document;
means of transposing said at least one meta-datum into a transposed datum;
means of inserting said transposed datum into a second part of said target document, distinct from said first part.

Such a device is especially able to implement the steps of the conversion method described previously.

An embodiment of the invention further relates to a device for converting a source document described in a source format to at least one target document described in a target format and at least one associated meta-datum, described in said target format or in a format which permits the generation of meta-data in said target format.

According to an embodiment of the invention, said source format complies with a first protocol for exchanging and/or sharing medical imaging documents and said target format complies with a second protocol for exchanging and/or sharing medical documents, and said device comprises:
means of inserting a first part of said source document into a first part of said target document;
means of transposing a second part of said source document into at least one meta-datum associated to said target document.

Such a device is especially able to implement the steps of the conversion method described previously.

An embodiment of the invention also relates to computer software that may be downloaded from a communication network and/or saved onto a support that may be read by a computer and/or executed by a processor, comprising program code instructions for the implementation of the conversion method of a medical document and associated meta-data to an imaging document as described previously, when said program is executed on a computer.

An embodiment of the invention finally relates to computer software that may be downloaded from a communication network and/or saved onto a support that may be read by a computer and/or executed by a processor, comprising program code instructions for the implementation of the conversion method of an imaging document to a medical document and associated meta-data as described previously, when said program is executed on a computer.

### BRIEF DESCRIPTION OF THE DRAWINGS

Other features and advantages will become clearer upon reading the following description of a specific embodiment, provided simply by way of illustration and in no way restrictively, and the appended drawings, wherein:

FIG. 1 illustrates an example of documents that may be converted from one to the other according to one embodiment of the invention;

FIG. 2 illustrates the main steps of the method for converting a medical document to an imaging document according to one embodiment of the invention;

FIG. 3 illustrates the main steps of the method for converting an imaging document to a medical document according to one embodiment of the invention;

FIG. 4 presents an example of the system in which the conversion methods according to one embodiment of the invention are implemented.

### DETAILED DESCRIPTION OF ILLUSTRATIVE EMBODIMENTS

### 1. General Principle

The general principle of an embodiment of the invention is based on the analysis of the formats of the source document and the target document so as to implement a distinct conversion for the different parts of the source document to the different parts of the target document.

Let us consider a first document format suited to the exchanging and sharing of medical documents and a second format suited to the exchanging and sharing of medical imaging documents.

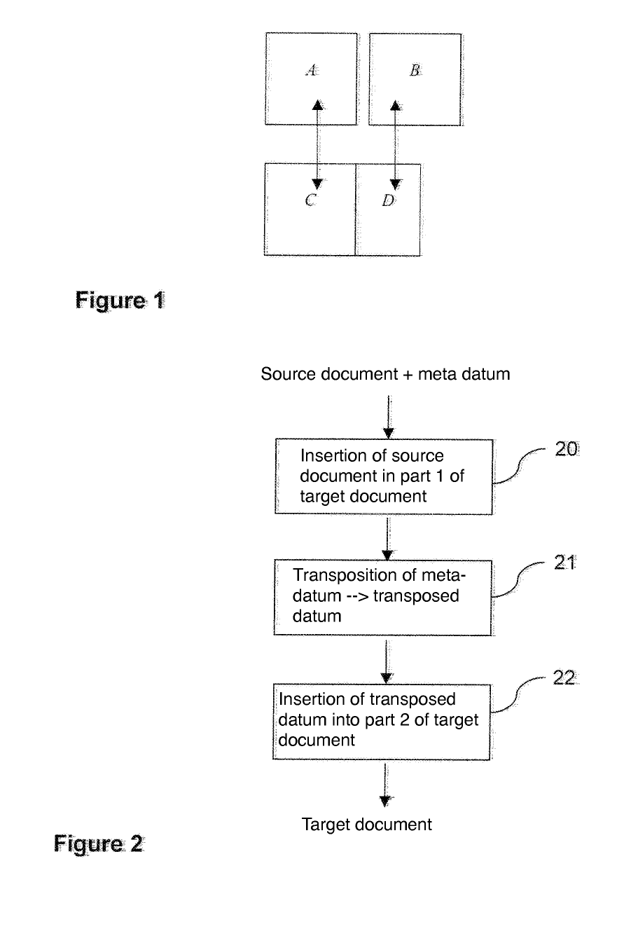

Now in relation to FIG. 1, an example of a medical document and associated meta-data are presented and an example of a medical imaging document, for the implementation of the conversion methods according to an embodiment of the invention.

A medical document B, associated to meta-data A, is considered, along with a medical imaging document composed of a first part D, corresponding to a binary part that is representative of an image and a second part C, corresponding to a header.

Below, in relation to FIGS. 1 and 2, the two conversion methods of exemplary embodiments of the invention are described, which permit the conversion from a medical document B associated to meta-data A, to an imaging document composed of parts C and D, and vice-versa.

In particular, specific embodiments are described in “IHE-XDS” medical document format and “DICOM” imaging format.

### 2. Conversion of a Medical Document and Associated Meta-Data to an Imaging Document

FIG. 2 illustrates the main steps of the method of converting a medical document, and associated meta-data, to an imaging document, according to a specific embodiment of the invention.

A medical document B is considered, for example a document associated to a hospitalised patient, corresponding to the patient's medical file comprising information on his/her pathology, the examinations and/or operations undergone, contact details, date of admission into the hospital, etc.

Meta-data A are associated to this document, which especially permit it to be managed within a file related to the patient, and which allow this document to be stored, shared and/or transferred to an addressee (for example, another hospital, or another attending physician, etc.).

It is desired to manage this medical document, as well as the associated meta-data, in a management system, for sharing and exchanging medical imaging documents, in the same way as an imaging document, without loss of information as regards the medical document and the meta-data.

To achieve this, the steps shown in FIG. 2 are implemented, for document B and each of the meta-data A.

The first step 20 consists of inserting the contents of the medical document B into a first part of an imaging document that is pre-identified.

In the example illustrated in FIG. 1, this step 20 consists of incorporating the content of the file corresponding to the document B into the binary part D of the imaging document.

In a second step 21, a meta-datum associated to the medical document is transposed into a transposed datum, which is compatible with the target format.

This step 21 corresponds, for the example illustrated in FIG. 1, to transposing the meta-data A into data which are compatible with the format of the headers C of the imaging documents.

This transposition step is described in more detail in the following paragraphs, in relation to examples of embodiments.

This transposed datum is then inserted, during a step 22, into a second specific part of the target document, corresponding in the example of FIG. 1 to the header C.

The binary part D and the header C thus generated form an imaging document which corresponds to the original medical document B and the associated meta-data A.

### 3. Conversion of an Imaging Document to a Medical Document and Associated Meta-Data

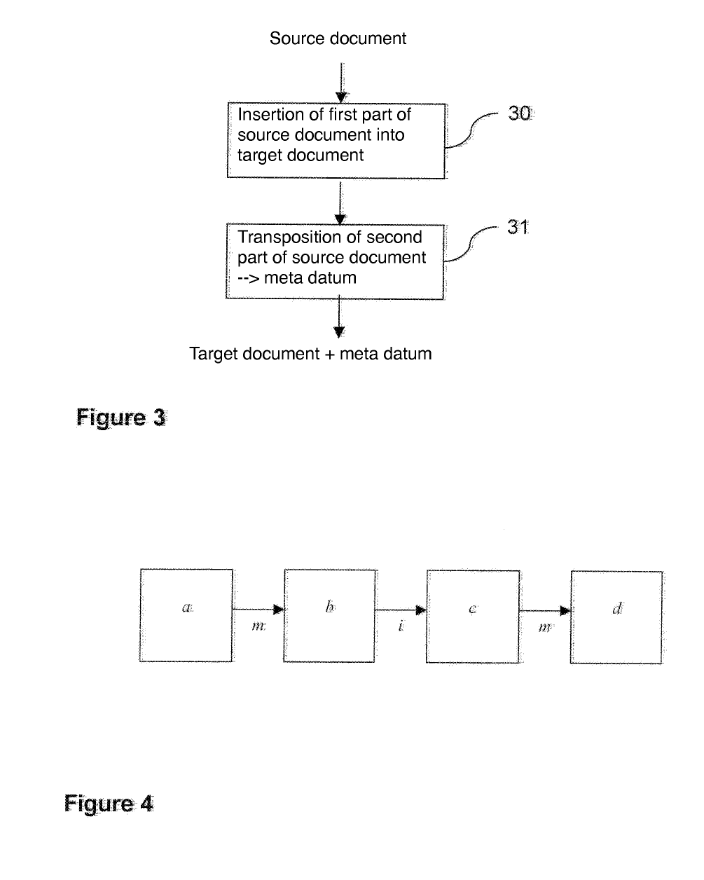

Now in relation to FIG. 3, the main steps of the method of converting an imaging document to a medical document and associated meta-data are presented, according to a specific embodiment of the invention.

This involves, in the example illustrated in FIG. 1, in converting an imaging document, composed of a binary part D and a header C, into a medical document B associated to meta-data A.

To achieve this, a first step 30 consists of inserting a first part of an imaging document, the binary part D for example, into the medical document B.

In a second step 31, a second part of the imaging document, the header C in the example, is transposed into at least one meta-datum associated to the medical document.

This transposition is described in more detail in the following paragraphs, in relation to embodiments.

### 4. Examples of Conversion of an Imaging Document to a Medical Document and Associated Meta-Data and Inversely

Now, in relation to FIG. 4, an example of an implementation of the conversion methods will be presented, according to one specific embodiment of the invention.

Two “medical image router” systems are considered, which correspond to, the systems b and c, which permit the secure exchange of images in “DICOM” format between two healthcare establishments, for example a and d.

One of the typical applications is the transfer of the Radiology shift between two establishments in the evening or at the weekend.

The invention, according to this specific embodiment, allows the association to the medical documents of non-imaging medical documents and their associated meta-data, taken for example from the patient file, managed by a system of the medical establishment a.

These non-imaging medical documents and their associated meta-data, are exported in a format m (for example “IHE-XDS”), suited to the medical documents and supported as standard by patient files.

According to this embodiment, the invention permits these medical documents to be transferred with the images between the two medical establishments (a and d) according to a format i (for example “DICOM).

The invention also permits, according to this embodiment, these medical documents to be viewed in the Radiology management system d, which supports an application for creating reports on the interpretation of the radiologies to which the documents were exported in format m.

The conversions from the format m to the format i and inversely are carried out using conversion tables, taking into consideration the architecture of the two formats.

In particular, Appendix 1, which is an integral part of this description, corresponds to the table which describes the conversions to be implemented for a specific embodiment of the invention, which allow a medical document and the associated meta-data to be converted, described in the “IHE-XDS” format, to an imaging document “DICOM” format.

The “XDS” meta-data are described in Volume 2 of the IHE Technical Framework IT Infrastructure, IHE_ITI_TF_{—}4.0_Vol2_FT_{—}2007-08-22.pdf or its update (www.ihe.net).

The header fields of the “DICOM” format are described in part 3 of the DICOM standard (PS3.3) (dicom.nema.org).

For example, let us consider an “XDS” attribute called “author” representing an author of the document, to be converted to the “DICOM” format.

This “XDS” attribute comprises a certain number of sub-attributes, such as: “authorinstitution”, “authorPerson”, “authorRole” and “authorSpecialty”.

The field of equivalent function to be used in “DICOM” is the “PersonIdentificationCodeSequence” sequence, marked by (0040,1101) comprising the following sub-fields: “CodeValue” (0008,0100), “CodeMeaning (0008,0104) and “CodeSchemeDesignator” (0008,0106) (in compliance with part 3 of the DICOM standard document.

For example, let us consider the “author” XDS attribute which has the following sub-attributes:

```
    ″authorInstitution″: value =
“Groupe Pitié Salpétrière\hat{ }\hat{ }\hat{ }\hat{ }\hat{ }&1.2.250.1.71&ISO\hat{ }G-
CPS\hat{ }\hat{ }\hat{ }1750100125”;
    ″authorPerson″: value =
“0993000462\hat{ }DURAND\hat{ }Romuald\hat{ }B\hat{ }\hat{ }Dr.\hat{ }\hat{ }\hat{ }&1.2.250.1.71&ISO\hat{ }\hat{ }\hat{ }\hat{ }G-
CPS”;
    ″authorRole″: value = “Médecin”
        ″authorSpecialty″: value = “Radiologie”.
```

These sub-attributes are coded as follows:

```
<Classification ...>
<Slot name=“authorPerson”>
    <ValueList><rim:Value>0993000462\hat{ }DURAND\hat{ }Romuald\hat{ }B\hat{ }\hat{ }Dr.
    </Value></ValueList></Slot>
<Slot name=“authorInstitution”>
    <ValueList><Value>Groupe Pitié
Salpétrière\hat{ }\hat{ }\hat{ }\hat{ }\hat{ }\hat{ }\hat{ }\hat{ }\hat{ }1750100125
    </Value></ValueList></Slot>
<Slot name=“authorRole”>
    <ValueList><Value>Médecin
    </Value></ValueList></Slot>
<Slot name=“authorSpecialty”>
    <ValueList><Value>Radiologie
    </Value></ValueList></Slot>
</Classification>
```

The “DICOM” correspondence for this attribute and these sub-attributes according to one embodiment of the invention is as follows:

```
(0040,A078) {
(0008,0080): [Groupe Pitié Salpétrière]
(0008,0082)
    {(0008,0100):
        [1750100125], (0008,0102):[NPI ],
(0008,0104):[1750100125]}
(0040,1101)
    {[(0008,0100):
        [0993000462],
(0008,0102):[UPIN],(0008,0104):[0993000462]}
    {[(0008,0100):
        [Médecin], (0008,0102):[ROLE],
(0008,0104):[Médecin ]}
    [(0008,0100):
    [Radiologie],(0008,0102):[SPECIALTY],(0008,0104):[Radio
logie]}
(0040,A084): [PSN ]
(0040,A123): [DURAND\hat{ }Romuald\hat{ }B\hat{ }\hat{ }Dr]
```

### 5. Appendix 1

General principles

| | |
|---|---|
| 1) Dates | Check that the dates correspond by using the DICOM field |
| | TimeZoneOffsetFromUTC (0008, 0201) |
| 2) Codes | Match up the values, labels and coding diagrams between the XDS and |
| | DICOM structures |
| | Value: CodeValue (0008, 0100) label (DisplayName): CodeMeaning |
| | (0008, 0104) |
| | Coding diagram: CodingSchemeDesignator (0008, 0102). The version |
| | should be empty |
| 3) Log-ins | The log-ins of persons and organisations comprise a log-in for an assigning |
| | authority or a log-in root and a log-in match the first to |
| | CodingSchemeDesignator (0008, 0102) and the second to CodeValue (0008, 0100). |
| 4) Exceptions | By principle, the output DICOM format complies totally with the standard. |
| | A few extensions have however been introduced but such that the PACS |
| | keep all of the objects, as no proprietor attribute has been created, and no |
| | type of attribute has been modified. The only two types of exceptions are |
| | as follows: |
| | certain attributes not planned for certain classes have been used, |
| | diagrammatically it can be considered that the header of “document” type |
| | instances is the merging of the headers of the DICOM SR, DICOM PDF |
| | and DICOM CDA, wherein only the useful attributes have been added |
| | certain sequences that appeared to have a single input have been |
| | extended, especially to allow certain log-ins to be managed, as well as one |
| | or two codes of the entities (institution for example) |

| | High | | | |
|---|---|---|---|---|
| XDS | level | | | |
| Attribute | tag | DICOM Module | DICOM Tag | DICOM Comment |
| D_authorInsti | 0040, | SOP COMMON | InstitutionName (0008, 0080) | |
| tution (sub- | A07C | and SR | and possibly | |
| attribute of | | DOCUMENT | InstitutionalDepartmentName | |
| author) | | GENERAL/ | (0008, 1040) | |
| | | AuthorObserver | | |
| | | Sequence | | |
| | | (0040, A078) and | | |
| | | CustodialOrgani | | |
| | | zationSequence | | |
| | | (0040, A07C) | | |
| D_authorPers | 0040, | SR | PersonName (00040, A123) and | ObserverType |
| on (sub- | A078 | DOCUMENT | PersonIdentificationSequence | (00040, A084) is to be |
| attribute of | | GENERAL/ | (0040, 1101) | set to PSN. Always |
| author) | | AuthorObserver | | initialise first input |
| | | Sequence | | |
| | | (0040, A078) | | |
| D_authorRole | 0040, | SR | CodeValue (0008, 0100) and | The second (the third |
| (sub-attribute | A078 | DOCUMENT | CodeMeaning (0008, 0104) | being for Speciality). |
| of author) | | GENERAL/ | | If specialty is not |
| | | AuthorObserver | | empty and role is |
| | | Sequence | | empty, set to |
| | | (0040, A078)/ | | UNKNOWN. Only |
| | | PersonIdentifica | | the first input of the |
| | | tionCodeSequen | | role is used, the others |
| | | ce (0040, 1101) | | are ignored. |
| D_authorSpe | 0040, | SR | CodeValue (0008, 0100) and | The third (the first |
| cialty (sub- | A078 | DOCUMENT | CodeMeaning (0008, 0104) | being for the log-in of |
| attribute of | | GENERAL/ | | the author's institution, |
| author) | | AuthorObserver | | the second for Role). |
| | | Sequence | | Only the first input is |
| | | (0040, A078) | | used, the others being |
| | | | | ignored |
| D_availabilit | | | | |
| yStatus | | | | |
| D_classCode | | | | Should be made |
| | | | | identical to typeCode |
| D_classCode | | | | Should be made |
| DisplayName | | | | identical to |
| | | | | typeCodeDisplayNam |
| | | | | e |
| D_comments | 0018, | SOP COMMON | ContributionDescription | |
| | A003 | | (0018, A003) | |
| D_confidenti | | | | Not managed so set to |
| alityCode | | | | the “normal” output |
| | | | | value |
| D_creationTi | 0008, | SOP COMMON | InstanceCreationDate | |
| me | 0012 | and | (0008, 0012), | |
| | | ENCAPSULAT | InstanceCreationTime | |
| | | ED DOCUMENT | (0008, 0013), | |
| | | | TimeZoneOffsetFromUTC | |
| | | | (0008, 0201) and DOC/ | |
| | | | ContentDate (0008, 0023), | |
| | | | ContentTime (0008, 0033), | |
| | | | AcquisitionDateTime | |
| | | | (0008, 002A) | |
| D_creationTi | 0008, | SOP COMMON | InstanceCreationDate | |
| me | 0013 | and | (0008, 0012), | |
| | | ENCAPSULAT | InstanceCreationTime | |
| | | ED | (0008, 0013), | |
| | | DOCUMENT | TimeZoneOffsetFromUTC | |
| | | | (0008, 0201) and DOC/ | |
| | | | ContentDate (0008, 0023), | |
| | | | ContentTime (0008, 0033), | |
| | | | AcquisitionDateTime | |
| | | | (0008, 002A) | |
| D_creationTi | 0008, | SOP COMMON | InstanceCreationDate | |
| me | 0023 | and | (0008, 0012), | |
| | | ENCAPSULAT | InstanceCreationTime | |
| | | ED | (0008, 0013), | |
| | | DOCUMENT | TimeZoneOffsetFromUTC | |
| | | | (0008, 0201) and DOC/ | |
| | | | ContentDate (0008, 0023), | |
| | | | ContentTime (0008, 0033), | |
| | | | AcquisitionDateTime | |
| | | | (0008, 002A) | |
| D_creationTi | 0008, | SOP COMMON | InstanceCreationDate | |
| me | 002A | and | (0008, 0012), | |
| | | ENCAPSULAT | InstanceCreationTime | |
| | | ED | (0008, 0013), | |
| | | DOCUMENT | TimeZoneOffsetFromUTC | |
| | | | (0008, 0201) and DOC/ | |
| | | | ContentDate (0008, 0023), | |
| | | | ContentTime (0008, 0033), | |
| | | | AcquisitionDateTime | |
| | | | (0008, 002A) | |
| D_creationTi | 0008, | SOP COMMON | InstanceCreationDate | |
| me | 0033 | and | (0008, 0012), | |
| | | ENCAPSULAT | InstanceCreationTime | |
| | | ED | (0008, 0013), | |
| | | DOCUMENT | TimeZoneOffsetFromUTC | |
| | | | (0008, 0201) and DOC/ | |
| | | | ContentDate (0008, 0023), | |
| | | | ContentTime (0008, 0033), | |
| | | | AcquisitionDateTime | |
| | | | (0008, 002A) | |
| D_creationTi | 0008, | SOP COMMON | InstanceCreationDate | |
| me | 0201 | and | (0008, 0012), | |
| | | ENCAPSULAT | InstanceCreationTime | |
| | | ED | (0008, 0013), | |
| | | DOCUMENT | TimeZoneOffsetFromUTC | |
| | | | (0008, 0201) and DOC/ | |
| | | | ContentDate (0008, 0023), | |
| | | | ContentTime (0008, 0033), | |
| | | | AcquisitionDateTime | |
| | | | (0008, 002A) | |
| D_entryUUI | | | | |
| D | | | | |
| D_eventCode | | | | |
| DisplayName | | | | |
| List | | | | |
| D_eventCode | | | | |
| List | | | | |
| D_formatCod | 0040, | (if CDA) SOP | SOPClassUID (0008, 0016) = | The correspondence |
| e | A390 | COMMON/HL7 | 2.16.840.1.113883.1.7.2 | between the DICOM |
| | | StructuredDocu | (CDAR2) or . . . 1 (R1) | classes and the |
| | | mentSequence | | formats depends on |
| | | (0040, A390) | | the XDS activity |
| | | | | domain (affinity |
| | | | | domain) |
| D_hash | | | | |
| D_healthcare | 0040, | SR GENERAL/ | CodeValue (0008, 0100), | The second of the |
| FacilityType | A07C | CustodialOrgani | CodingSchemeDesignator | sequence (the first is |
| Code | | zationSequence | (0008, 0102) | used for the ID of the |
| | | (0040, A07C)/ | | institution and the |
| | | InstitutionCodeS | | third for |
| | | equence | | healthcareFacility) |
| | | (008, 0082) | | |
| D_healthcare | 0040, | SR GENERAL/ | CodeMeaning (0008, 0100) | The second of the |
| FacilityType | A07C | CustodialOrgani | | sequence (the first is |
| CodeDisplay | | zationSequence | | used for the ID of the |
| Name | | (0040, A07C)/ | | institution and the |
| | | InstitutionCodeS | | third for |
| | | equence | | healthcareFacility) |
| | | (0008, 0082) | | |
| D_languageC | 0008, | SOP COMMON | SpecificCharacterSet | Depending on the |
| ode | 0005 | | (0008, 0005) | language (FR ó |
| | | | | ISO_IR 100 . . .) |
| D_legalAuthe | 0040, | SR GENERAL/ | VerifyingObserverName | If present, set the |
| nticator | A073 | VerifyingObserv | (0040, A075) and | VerificationFlag |
| | | erSequence | VerifyingObserverIdentificatio | (0040, A493) to |
| | | (0040, A073) | nSequence (0040, A088) | VERIFIED otherwise |
| | | | | to UNVERIFIED |
| D_mimeType | 0042, | ENCAPSULAT | MIMETypeOfEncapsulatedDoc | |
| | 0012 | ED | ument (0042, 0012) | |
| | | DOCUMENT | | |
| D_parentDoc | | | | Can be managed if |
| umentId | | | | required in SR type |
| | | | | header |
| D_parentDoc | | | | See above |
| umentRelatio | | | | |
| nship | | | | |
| D_patientId | 0010, | PATIENT | PatientID (0010, 0020) and | |
| | 0020 | | IssuerOfPatientID (0010, 0021) | |
| D_patientId | 0010, | PATIENT | PatientID (0010, 0020) and | |
| | 0021 | | IssuerOfPatientID (0010, 0021) | |
| D_practiceSet | 0040, | SR GENERAL/ | CodeValue (0008, 0100), | The third of the |
| tingCode | A07C | CustodialOrgani | CodingSchemeDesignator | sequence (the first is |
| | | zationSequence | (0008, 0102) | used for the ID of the |
| | | (0040, A07C)/ | | institution and the |
| | | InstitutionCodeS | | second for |
| | | equence | | healthcareFacility) |
| | | (008, 0082) | | |
| D_practiceSet | 0040, | SR GENERAL/ | CodeMeaning (0008, 0100) | The third of the |
| tingCode | A07C | CustodialOrgani | | sequence (the first is |
| DisplayName | | zationSequence | | used for the ID of the |
| | | (0040, A07C)/ | | institution and the |
| | | InstitutionCodeS | | second for |
| | | equence | | healthcareFacility) |
| | | (008, 0082) | | |
| D_serviceStar | 0008, | | | Not to be initialised |
| tTime | 0020 | | | from this value but in |
| | | | | the other sense, this |
| | | | | value may be |
| | | | | initialised from the |
| | | | | info in the |
| | | | | examination header |
| | | | | (GENERAL |
| | | | | STUDY/StudyDate |
| | | | | (0008, 0020) and |
| | | | | StudyTime |
| | | | | (0008, 0030) |
| D_serviceStar | 0008, | | | Not to be initialised |
| tTime | 0030 | | | from this value but in |
| | | | | the other sense, this |
| | | | | value may be |
| | | | | initialised from the |
| | | | | info in the |
| | | | | examination header |
| | | | | (GENERAL |
| | | | | STUDY/StudyDate |
| | | | | (0008, 0020) and |
| | | | | StudyTime |
| | | | | (0008, 0030) |
| D_serviceSto | | | | |
| pTime | | | | |
| D_size | | | | |
| D_sourcePati | 0010, | PATIENT | OtherPatientID (0010, 0020) | In the case where |
| entId | 0020 | | | there is reconciliation, |
| | | | | the OtherPatientId |
| | | | | field allows the |
| | | | | original name to be |
| | | | | recovered |
| D_sourcePati | 0010, | PATIENT | PatientsName (0010, 0010), | In the case where |
| entInfo | 0010 | | PatientsBirthDate (0010, 0030), | there is reconciliation, |
| | | | PatientsBirthTime (0010, 0032), | the OtherPatientName |
| | | | PatientsSex (0010, 0040), | field allows the |
| | | | Patients Address (0010, 1040) | original name to be |
| | | | and OtherPatientNames | recovered |
| | | | (0010, 1001) | |
| D_sourcePati | 0010, | PATIENT | PatientsName (0010, 0010), | In the case where |
| entInfo | 0030 | | PatientsBirthDate (0010, 0030), | there is reconciliation, |
| | | | PatientsBirthTime (0010, 0032), | the OtherPatientName |
| | | | PatientsSex (0010, 0040), | field allows the |
| | | | Patients Address (0010, 1040) | original name to be |
| | | | and OtherPatientNames | recovered |
| | | | (0010, 1001) | |
| D_sourcePati | 0010, | PATIENT | PatientsName (0010, 0010), | In the case where |
| entInfo | 0032 | | PatientsBirthDate (0010, 0030), | there is reconciliation, |
| | | | PatientsBirthTime (0010, 0032), | the OtherPatientName |
| | | | PatientsSex (0010, 0040), | field allows the |
| | | | Patients Address (0010, 1040) | original name to be |
| | | | and OtherPatientNames | recovered |
| | | | (0010, 1001) | |
| D_sourcePati | 0010, | PATIENT | PatientsName (0010, 0010), | In the case where |
| entInfo | 0040 | | PatientsBirthDate (0010, 0030), | there is reconciliation, |
| | | | PatientsBirthTime (0010, 0032), | the OtherPatientName |
| | | | PatientsSex (0010, 0040), | field allows the |
| | | | Patients Address (0010, 1040) | original name to be |
| | | | and OtherPatientNames | recovered |
| | | | (0010, 1001) | |
| D_sourcePati | 0010, | PATIENT | PatientsName (0010, 0010), | In the case where |
| entInfo | 1000 | | PatientsBirthDate (0010, 0030), | there is reconciliation, |
| | | | PatientsBirthTime (0010, 0032), | the OtherPatientName |
| | | | PatientsSex (0010, 0040), | field allows the |
| | | | Patients Address (0010, 1040) | original name to be |
| | | | and OtherPatientNames | recovered |
| | | | (0010, 1001) | |
| D_sourcePati | 0010, | PATIENT | PatientsName (0010, 0010), | In the case where |
| entInfo | 1001 | | PatientsBirthDate (0010, 0030), | there is reconciliation, |
| | | | PatientsBirthTime (0010, 0032), | the OtherPatientName |
| | | | PatientsSex (0010, 0040), | field allows the |
| | | | Patients Address (0010, 1040) | original name to be |
| | | | and OtherPatientNames | recovered |
| | | | (0010, 1001) | |
| D_title | 0042, | ENCAPSULAT | DocumentTitle (0042, 0010) | |
| | 0010 | ED | | |
| | | DOCUMENT | | |
| D_typeCode | 0040, | ENCAPSULAT | CodeValue (0008, 0100) | Type of code = Loine |
| | A043 | ED | | (LN) or other in |
| | | DOCUMENT/ | | CodingSchemeDesign |
| | | ConceptNameC | | ator (0008, 0102) or |
| | | odeSequence | | even version in |
| | | (0040, A043) | | CodingSchemeVersio |
| | | | | n (0008, 0103) |
| D_typeCode | 0040, | ENCAPSULAT | CodeMeaning (0008, 0104) | See above |
| DisplayName | A043 | ED | | |
| | | DOCUMENT/ | | |
| | | ConceptNameC | | |
| | | odeSequence | | |
| | | (0040, A043) | | |
| D_uniqueId | 0040, | SOP | SOPInstanceUID (0008, 0018), | Processing different if |
| | A390 | COMMON, | ENC./InstanceNumber | “pure” or “extended” |
| | | ENCAPSULAT | (0020, 0013) and | UID: if uniqueID is |
| | | ED | HL7/HL7InstanceIdentifier | “pureID”, use it as |
| | | DOCUMENT | (0040, E001) si CDA | SOP Instance UID, |
| | | and SOP | | otherwise create one. |
| | | COMMON/HL7 | | Always put UniqueID |
| | | StructuredDocu | | in InstanceNumber |
| | | mentSequence | | and possibly also in |
| | | (0040, A390) | | the HL7 structure if |
| | | | | the document is CDA |
| D_URI | 0040, | SOP | RetrieveURI (0040, E010) | Completed by the |
| | A390 | COMMON/HL7 | | server based on a |
| | | StructuredDocu | | simplified WADO e.g. |
| | | mentSequence | | if there is an |
| | | (0040, 0390) | | advantage to do so |
| | | | | (which needs to be |
| | | | | proved) |
| S_authorInstit | 0008, | GENERAL | InstitutionName (0008, 0080), | |
| ution (sub- | 1052 | SERIES/ | InstitutionCodeSequence | |
| attribute of | | PerformingPhys | (0008, 0082) | |
| author) | | icianIdentificati | | |
| | | onSequence | | |
| | | (0008, 1052) | | |
| S_authorPers | 0008, | GENERAL | PerformingPhysiciansName | Exception, add this |
| on (sub- | 1050 | SERIES | (0008, 1050) and | field of the general |
| attribute of | | | PersonIdentificationCodeSeque | header of the series to |
| author) | | | nce (0040, 1101) | the document series |
| | | | | header. Use the first |
| | | | | input for the author |
| | | | | log-in. Only the first |
| | | | | input of the author is |
| | | | | used. |
| S_authorRole | 0008, | GENERAL | PersonIdentificationCodeSeque | The second input (set |
| (sub-attribute | 1052 | SERIES/ | nce (0040, 1101)/CodeValue | to UNKNOWN) if the |
| of author) | | PerformingPhys | (0008, 0100), CodeMeaning | role is empty but the |
| | | icianIdentificati | (0008, 0104) and | specialty is not. Only |
| | | onSequence | CodingSchemeDesignator | the first input of the |
| | | (0008, 1052) | (0008, 0102) | role is used, the other |
| | | | | being ignored. |
| S_authorSpec | 0008, | GENERAL | PersonldentificationCodeSeque | The third input if not |
| ialty (sub- | 1052 | SERIES/ | nce (0040, 1101)/CodeValue | empty. Only the first |
| attribute of | | PerformingPhys | (0008, 0100), CodeMeaning | input of the specialty |
| author) | | icianIdentificati | (0008, 0104) and | is used, the other |
| | | onSequence | CodingSchemeDesignator | being ignored |
| | | (0008, 1052) | (0008, 0102) | |
| S_availability | | | | |
| Status | | | | |
| S_comments | 0008, | ENCAPSULAT | PerformedProcedureStepDescri | If not empty Series |
| | 103E | ED | ption (0040, 0254), or even | description if |
| | | DOCUMENT | SeriesDescrition (0008, 103E) | comments not empty |
| | | SERIES | | and title empty. |
| S_comments | 0040, | ENCAPSULAT | PerformedProcedureStepDescri | If not empty Series |
| | 0254 | ED | ption (0040, 0254), or even | description if |
| | | DOCUMENT | SeriesDescrition (0008, 103E) | comments not empty |
| | | SERIES | | and title empty |
| S_contentTyp | 0040, | ENCAPSULAT | CodeValue (0008, 0100) | With |
| eCode | 0260 | ED | | CodingSchemeDesign |
| | | DOCUMENT | | er (0008, 0102) |
| | | SERIES/ | | |
| | | PerformedProto | | |
| | | colCodeSequenc | | |
| | | e (0040, 0260) | | |
| S_contentTyp | 0040, | ENCAPSULAT | CodeMeaning (0008, 0104) | |
| eCodeDisplay | 0260 | ED | | |
| Name | | DOCUMENT | | |
| | | SERIES/ | | |
| | | PerformedProto | | |
| | | colCodeSequenc | | |
| | | e (0040, 0260) | | |
| S_entryUUID | | | | |
| S_intendedRe | 0008, | GENERAL | ReferringPhysiciansName | Only the first |
| cipient | 0090 | STUDY | (0008, 0090) | addressee is stored in |
| | | MODULE | | this field |
| S_intendedRe | 0008, | GENERAL | ReferringPhysicianIdentificatio | Only the first |
| cipient | 0096 | STUDY | nSequence (0008, 0096) | addressee is stored in |
| | | MODULE | | this field |
| S_patientId | 0010, | PATIENT | PatientID (0010, 0020) and | |
| | 0020 | | IssuerOfPatientID (0010, 0021) | |
| S_patientId | 0010, | PATIENT | PatientID (0010, 0020) and | |
| | 0021 | | IssuerOfPatientID (0010, 0021) | |
| S_sourceId | 0008, | SOP COMMON | InstanceCreatorUID | |
| | 0014 | | (0008, 0014) | |
| S_submission | 0040, | ENCAPSULAT | PerformedProcedureStepStartD | |
| Time | 0244 | ED | ate (0040, 0244), | |
| | | DOCUMENT | PerformedProcedureStepStartTi | |
| | | SERIES | me (0040, 0254) | |
| S_submission | 0040, | ENCAPSULAT | PerformedProcedureStepStartD | |
| Time | 0245 | ED | ate (0040, 0244), | |
| | | DOCUMENT | PerformedProcedureStepStartTi | |
| | | SERIES | me (0040, 0254) | |
| S_title | 0008, | ENCAPSULAT | SeriesDescription (0008, 103E) | If not empty PPS |
| | 103E | ED | or even | description if |
| | | DOCUMENT | PerformedProcedureStepDescri | comments empty |
| | | SERIES | ption (0040, 0254) | |
| S_uniqueId | 0020, | ENCAPSULAT | SeriesInstanceUID (0020, 000E) | |
| | 000E | ED | | |
| | | DOCUMENT | | |
| | | SERIES | | |

At least one embodiment of the disclosure provides a technique which permits the storage and transmission of different types (text, images, etc.) of medical documents to be optimised.

At least one embodiment enables medical documents to be managed within imaging systems, and imaging documents within information systems managing medical documents.

At least one embodiment provides such a technique that has enhanced performances in terms of the exchanges of medical documents and associated images.

At least one embodiment provides such a technique that is both simple and inexpensive to implement.

At least one embodiment provides such a technique that is compatible with existing formats of medical documents and imaging documents.

Although the present disclosure has been described with reference to one or more examples, workers skilled in the art will recognize that changes may be made in form and detail without departing from the scope of the disclosure and/or the appended claims.

1. A method for converting a source document described in a source format and at least one associated meta-datum described in said source format or in a format which permits meta-data to be generated in said source format, to at least one target document described in a target format, in a conversion device, so that the target document may be stored in an information system, transmitted to an imaging system, or both stored and transmitted,
wherein said source format is compliant with a first protocol for at least one of exchanging or sharing of non-imaging medical documents and said target format is compliant with a second protocol for at least one of exchanging or sharing of digital medical imaging documents,
and wherein said method comprises the following steps:
insertion of said source document in a first part of said target document;
transposition of said at least one meta-datum into a transposed datum; and
insertion of said transposed datum into a second part of said target document, distinct from said first part.

2. The conversion method of claim 1, wherein said transposition step comprises the following sub-steps:
decoding said at least one meta-datum;
identification, from a plurality of fields comprised in said second part of said target document, of a field which performs a function equivalent to that of said at least one meta-datum; and
conversion of said at least one meta-datum into said transposed datum to be inserted into said identified field.

3. The method of claim 2, wherein said identification step comprises the following sub-steps:
determination of a level of information of said meta-datum;
selection of said field in function of said determined level.

4. The method of claim 3, wherein said level of information belongs to the group, comprising:
a level related to a patient to whom said source document is linked;
a level related to a set of documents to which said source document belongs, called a submission batch;
a level related to the source document.

5. The method of claim 1, wherein said transposition step takes into account at least one item of information belonging to the group comprising:
an item of information related to a patient;
an item of information related to a submission batch;
an item of information related to said source document.

6. The method of claim 1, wherein said source format is an Integrating the Healthcare Enterprise, Cross Enterprise Document Sharing “IHE-XDS” format and said target format is a Digital Imaging and Communications in Medicine “DICOM” format.

7. A method for converting a source document described in a source format to at least one target document described in a target format and at least one associated meta-datum described in said target format or in a format which permits meta-data to be generated in said target format, in a conversion device, so that the target document may be stored in an imaging system, transmitted to an information system, or both stored and transmitted,
wherein said source format is compliant with a first protocol for at least one of exchanging or sharing of digital medical imaging documents and said target format is compliant with a second protocol for least one of exchanging or sharing of digital non-imaging medical documents,
and wherein said method comprises the following steps:
insertion of a first part of said source document in said target document; and
transposition of a second part of said source document into at least one meta-datum associated to said target document.

8. The method of claim 7, wherein said transposition step comprises the following sub-steps:
decoding said at least one field of said second part of said source document;
identification of a meta-datum associated to said target document performing a function equivalent to that of said field;
conversion of said field into at least one identified meta-datum.

9. The method of claim 8, wherein said identification step comprises the following sub-steps:
determination of a level of information of said identified field;
selection of said meta-datum in function of said determined level.

10. The method of claim 9, wherein said level of information belongs to the group, comprising:
a level related to a patient to whom said source document is linked;
a level related to an examination undergone by a patient;
a level related to a set of documents to which said source document belongs;
a level related to said source document.

11. The method of claim 7, wherein said transposition step takes into account at least one item of information belonging to the group comprising:
an item of information related to a patient;
an item of information related to an examination;
an item of information related to a related to a set of documents;
an item of information related to said source document.

12. The method of claim 7, wherein said source format is a Digital Imaging and Communications in Medicine “DICOM” format and said target format is an Integrating the Healthcare Enterprise, Cross Enterprise Document Sharing “IHE-XDS” format.

13. A device for converting a source document described in a source format and at least one associated meta-datum described in said source format or in a format which permits the generation of meta-data in said source format to at least one target document described in a target format, so that the target document may be stored in an information system, transmitted to an imaging system, or both stored and transmitted,
wherein said source format is compliant with a first protocol for at least one of exchanging or sharing of non-imaging medical documents and said target format is compliant with a second protocol for at least one of exchanging or sharing of digital medical imaging documents and wherein said device comprises:
means for inserting said source document into a first part of said target document;
means for transposing said at least one meta-datum into a transposed datum; and
means for inserting said transposed datum into a second part of said target document, distinct from said first part.

14. A device for converting a source document described in a source format to at least one target document described in a target format and at least one associated meta-datum, described in said target format or in a format which permits generation of meta-data in said target format, so that the target document may be stored in an imaging system, transmitted to an information system, or both stored and transmitted,
wherein said source format complies with a first protocol for at least one of exchanging or sharing digital medical imaging documents and said target format complies with a second protocol for at least one of exchanging or sharing non-imaging medical documents,
and wherein said device comprises:
means for inserting a first part of said source document into a first part of said target document; and
means for transposing a second part of said source document into at least one meta-datum associated to said target document.

15. A computer readable support that may be read by a computer and comprises program code instructions saved thereon for implementing a conversion method when said instructions are executed on a computer, wherein the conversion method comprises:
converting a source document described in a source format and at least one associated meta-datum described in said source format or in a format which permits meta-data to be generated in said source format, to at least one target document described in a target format, in a conversion device, so that the target document may be stored in an information system, transmitted to an imaging system, or both stored and transmitted, wherein said source format is compliant with a first protocol for at least one of exchanging or sharing of non-imaging medical documents and said target format is compliant with a second protocol for at least one of exchanging or sharing of digital medical imaging documents, and wherein converting comprises:
insertion of said source document in a first part of said target document;
transposition of said at least one meta-datum into a transposed datum; and
insertion of said transposed datum into a second part of said target document, distinct from said first part.

16. A computer readable support that may be read by a computer and comprises program code instructions for implementing a conversion method when said program is executed on a computer, wherein the conversion method comprises:
converting a source document described in a source format to at least one target document described in a target format and at least one associated meta-datum described in said target format or in a format which permits meta-data to be generated in said target format, in a conversion device, so that the target document may be stored in an imaging system, transmitted to an information system, or both stored and transmitted, wherein said source format is compliant with a first protocol for at least one of exchanging or sharing of digital medical imaging documents and said target format is compliant with a second protocol for at least one of exchanging or sharing of digital non-imaging medical documents, and wherein converting comprises:
insertion of a first part of said source document in said target document; and
transposition of a second part of said source document into at least one meta-datum associated to said target document.
